(19) United States
(12) Patent Application Publication
(10) Pub. No.: US 2024/0294749 A1
(43) Pub. Date: Sep. 5, 2024

(54) Thermoplastic Resin Composition and Molded Article Formed Therefrom

(71) Applicant: LOTTE CHEMICAL CORPORATION, Seoul (KR)

(72) Inventors: Sang Hwa LEE, Uiwang-si (KR); Chan Moo PARK, Uiwang-si (KR); Cheol Hoon JANG, Uiwang-si (KR); Bong Jae LEE, Uiwang-si (KR)

(21) Appl. No.: 18/574,440

(22) PCT Filed: Jun. 28, 2022
(86) PCT No.: PCT/KR2022/009194

§ 371 Date: Dec. 27, 2023

(30) Foreign Application Priority Data
Jun. 30, 2021 (KR) 10-2021-0085781

(51) Int. Cl. C08L 69/00; C08K 7/14

(52) U.S. Cl. CPC C08L 69/00; C08K 7/14

(57) ABSTRACT

A thermoplastic resin composition of the present invention comprises: approximately 100 parts by weight of a polycarbonate resin; approximately 20-80 parts by weight of a polyphenylene ether resin; approximately 15-70 parts by weight of glass fiber; approximately 1-10 parts by weight of epoxy-modified polystyrene; approximately 1-20 parts by weight of a styrene-ethylene/butylene-styrene copolymer; and approximately 0.2-4 parts by weight of dihydro-9-oxa-10-phosphaphenanthrene-10-oxide (DOPO), wherein the weight ratio of the epoxy-modified polystyrene and the styrene-ethylene/butylene-styrene copolymer is approximately 1:0.5 to 1:10. The thermoplastic resin composition has excellent impact resistance, flowability, appearance characteristics and the like, and has low dielectric constant, dielectric loss and the like.

### TECHNICAL FIELD

The present invention relates to a thermoplastic resin composition and a molded article formed therefrom. More specifically, the present invention relates to a thermoplastic resin composition having excellent impact resistance, flowability, appearance characteristics, or the like and a low dielectric constant, dielectric loss rate, or the like, and a molded article formed therefrom.

### BACKGROUND ART

Thermoplastic resin compositions comprising polycarbonate resins have lower specific gravity than glass and metal and exhibit excellent physical properties such as moldability and impact resistance, and thus they are useful for housings of electrical/electronic products, interior/exterior materials for automobiles, and exterior materials for construction.

However, when such thermoplastic resin compositions are used for purposes such as housings for mobile phones, there is a problem that communication performance deteriorates due to the high dielectric constant. Recently, with the development of mobile phone communication networks, the frequency range is changing to a (ultra)high frequency band, and so the application of materials with a low-dielectric constant and a low-dielectric loss rate as housing materials for mobile phones, or the like is becoming an essential requirement.

Therefore, there is a need to develop a thermoplastic resin composition having excellent impact resistance, flowability, appearance characteristics, or the like and a low dielectric constant, dielectric loss rate, or the like.

The background technique of the present invention is disclosed in Japanese Patent Publication No. 2012-533645, or the like.

### DISCLOSURE

### Technical Problem

It is an object of the present invention to provide a thermoplastic resin composition having excellent impact resistance, flowability, appearance characteristics, or the like and a low dielectric constant, dielectric loss rate, or the like.

It is another object of the present invention to provide a molded article formed from the thermoplastic resin composition.

The above and other objects of the present invention can be achieved by embodiments of the present invention described below.

### Technical Solution

1. One aspect of the present invention relates to a thermoplastic resin composition. The thermoplastic resin composition comprises: about 100 parts by weight of a polycarbonate resin; about 20 to about 80 parts by weight of a polyphenylene ether resin; about 15 to about 70 parts by weight of glass fiber; about 1 to about 10 parts by weight of an epoxy-modified polystyrene; about 1 to about 20 parts by weight of a styrene-ethylene/butylene-styrene copolymer; and about 0.2 to about 4 parts by weight of DOPO (dihydro-9-oxa-10-phosphaphenanthrene-10-oxide), wherein a weight ratio of the epoxy-modified polystyrene and the styrene-ethylene/butylene-styrene copolymer is about 1:0.5 to about 1:10.
2. In embodiment 1, the polyphenylene ether resin may comprise a repeating unit represented by Chemical Formula 1 below:

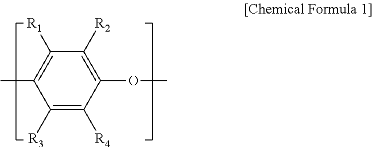

in Chemical Formula 1 above, R₁, R₂, R₃, and R₄ are each independently a hydrogen atom, a halogen atom, a C1 to C6 alkyl group or a C6 to C12 aryl group.
3. In embodiment 1 or 2, the epoxy-modified polystyrene may be obtained by polymerizing polystyrene with an epoxy compound comprising one or more of glycidyl (meth)acrylate, allyl glycidyl ether, and 2-methylallyl glycidyl ether.
4. In embodiments 1 to 3, in the epoxy-modified polystyrene, the content of the epoxy compound may be about 0.3% by weight to about 3% by weight.
5. In embodiments 1 to 4, the epoxy-modified polystyrene may comprise glycidyl (meth)acrylate-modified polystyrene.
6. In embodiments 1 to 5, the styrene-ethylene/butylene-styrene copolymer may have a melt flow index (MI) of about 10 to about 50 g/10 min, as measured under conditions of 200° C. and 5 kgf according to ASTM D1238.
7. In embodiments 1 to 6, a weight ratio of the epoxy-modified polystyrene and the DOPO may be about 1:0.1 to about 1:0.8.
8. In embodiments 1 to 7, the thermoplastic resin composition may have a notched Izod impact strength of about 10 to about 20 kgf·cm/cm, as measured with a ⅛″ thick specimen according to ASTM D256.
9. In embodiments 1 to 8, the thermoplastic resin composition may have a melt flow index (MI) of about 5 to about 10 g/10 min, as measured under conditions of 300° C. and 1.2 kgf according to ASTM D1238.
10. In embodiments 1 to 9, the thermoplastic resin composition may have a glossiness of about 50 to about 70 GU, as measured at a reflection angle of 75° using a glossmeter.
11. In embodiments 1 to 10, the thermoplastic resin composition may have a dielectric constant (Dk) of about 2.6 to about 2.8, as measured with a specimen having a size of 2.5 mm×50 mm×90 mm at 3.1 GHz using a split post dielectric resonator (SPDR) method.
12. In embodiments 1 to 11, the thermoplastic resin composition may have a dielectric loss rate (Df) of about 0.004 to about 0.006, as measured with a specimen having a size of 2.5 mm×50 mm×90 mm at 3.1 GHz using a split post dielectric resonator (SPDR) method.
13. Another aspect of the present invention relates to a molded article. The molded article is formed of the thermoplastic resin composition according to any one of embodiments 1 to 12.

### Advantageous Effects

The present invention provides a thermoplastic resin composition having good properties in terms of impact resistance, flowability, appearance characteristics, or the like, and a low dielectric constant, dielectric loss rate, or the like, and a molded article formed therefrom.

### BEST MODE

Hereinafter, embodiments of the present invention will be described in detail.

A thermoplastic resin composition according to the present invention comprises: (A) a polycarbonate resin; (B) a polyphenylene ether resin; (C) glass fiber; (D) epoxy-modified polystyrene; (E) a styrene-ethylene/butylene-styrene copolymer; and (F) DOPO.

As used herein to represent a specific numerical range, “a to b” means “≥a and ≤b”.

### (A) Polycarbonate Resin

As the polycarbonate resin according to one embodiment of the present invention, a polycarbonate resin used in conventional thermoplastic resin compositions may be used. For example, an aromatic polycarbonate resin prepared by reacting diphenols (aromatic diol compounds) with precursors, such as phosgene, halogen formate, and carbonic acid diester, may be used.

In an embodiment, examples of the diphenols may comprise 4,4′-biphenol, 2,2-bis(4-hydroxyphenyl)propane, 2,4-bis(4-hydroxyphenyl)-2-methylbutane, 1,1-bis(4-hydroxyphenyl)cyclohexane, 2,2-bis(3-chloro-4-hydroxyphenyl)propane, 2,2-bis(3,5-dichloro-4-hydroxyphenyl)propane, 2,2-bis(3-methyl-4-hydroxyphenyl)propane, and 2,2-bis(3,5-dimethyl-4-hydroxyphenyl)propane, but are not limited thereto. For example, 2,2-bis(4-hydroxyphenyl)propane, 2,2-bis(3,5-dichloro-4-hydroxyphenyl)propane, 2,2-bis(3,5-dimethyl-4-hydroxyphenyl)propane, or 1,1-bis(4-hydroxyphenyl)cyclohexane may be used, and specifically, 2,2-bis(4-hydroxyphenyl)propane, which is referred to as bisphenol-A, may be used.

In an embodiment, the polycarbonate resin may be one with a branched chain, for example, a branched polycarbonate resin prepared by adding, based on total diphenols used in polymerization, about 0.05 to about 2 mol % of a trivalent or higher polyfunctional compound, specifically, a compound having a trivalent or higher phenol group.

In an embodiment, the polycarbonate resin may be used in the form of a homopolycarbonate resin, a copolycarbonate resin, or a blend thereof. In addition, the polycarbonate resin may be partially or entirely replaced with an aromatic polyester-carbonate resin obtained by polymerization of an ester precursor, for example, in the presence of a difunctional carboxylic acid.

In an embodiment, the polycarbonate resin may have a weight average molecular weight (Mw) of about 10,000 to about 50,000 g/mol, for example, about 15,000 to about 40,000 g/mol, as measured by gel permeation chromatography (GPC). Within the above range, the flowability (processability), or the like of a thermoplastic resin composition may be excellent.

### (B) Polyphenylene Ether Resin

As the polyphenylene ether resin according to one embodiment of the present invention, a polyphenylene ether resin that is used in a conventional thermoplastic resin composition may be used as long as it is capable of lowering the dielectric constant, dielectric loss rate, or the like of a thermoplastic resin composition using the characteristics of having a dielectric constant and a dielectric loss rate lower than those of a polycarbonate resin. For example, a polyphenylene ether resin comprising a repeating unit represented by Chemical Formula 1 below may be used.

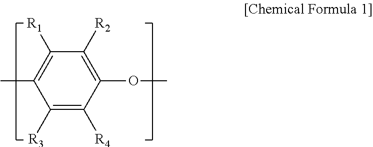

In Chemical Formula 1 above, R₁, R₂, R₃, and R₄ are each independently a hydrogen atom, a halogen atom, a C to C6 alkyl group or a C6 to C12 aryl group.

In an embodiment, examples of the polyphenylene ether resin may comprise poly(1,4-phenylene) ether, poly(2,6-dimethyl-1,4-phenylene) ether, and poly(2,6-diethyl-1,4-phenylene) ether, poly(2,6-dipropyl-1,4-phenylene) ether, poly(2-methyl-6-ethyl-1,4-phenylene) ether, poly(2-methyl)-6-propyl-1,4-phenylene) ether, poly(2-ethyl-6-propyl-1,4-phenylene) ether, poly(2,6-diphenyl-1,4-phenylene) ether, a copolymer of poly(2,6-diphenyl-1,4-phenylene) ether and poly(2,3,6-trimethyl-1,4-phenylene) ether, and a copolymer of poly(2,6-dimethyl-1,4-phenylene) ether and poly(2,3,5-triethyl-1,4-phenylene) ether.

In an embodiment, the polyphenylene ether resin may have a weight average molecular weight of about 10,000 to about 50,000 g/mol, for example, about 20,000 to about 40,000 g/mol, as measured by gel permeation chromatography (GPC).

In an embodiment, the polyphenylene ether resin may be comprised in an amount of about 20 to about 80 parts by weight, for example, about 30 to about 78 parts by weight, based on about 100 parts by weight of the polycarbonate resin. When the content of the polyphenylene ether resin is less than about 20 parts by weight based on about 100 parts by weight of the polycarbonate resin, there is a concern that the dielectric constant, dielectric loss rate, or the like of a thermoplastic resin composition (molded article) may increase, and when it exceeds about 80 parts by weight, there is a concern that the impact resistance, flowability, appearance characteristics, or the like of a thermoplastic resin composition (molded product) may be reduced.

### (C) Glass Fiber

As the glass fiber according to one embodiment of the present invention, a low-dielectric glass fiber used in a conventional low-dielectric thermoplastic resin composition may be used as long as it is capable of improving mechanical properties of a thermoplastic resin composition, such as rigidity and impact resistance, and lowering the dielectric constant, or the like thereof.

In an embodiment, the glass fiber may be in the form of a fiber and may have a cross-section of various shapes such as circular, oval, or rectangular. For example, it may be preferable in terms of mechanical properties to use fibrous glass fiber with a circular and/or rectangular cross-section.

In an embodiment, the glass fiber with the circular cross-section may have a cross-sectional diameter of about 5 to about 20 μm and a length before processing of about 2 to about 20 mm, and the glass fiber of the rectangular cross-section may have a cross-sectional aspect ratio (the major diameter of the cross-section/the minor diameter of the cross-section) of about 1.5 to about 10, a minor diameter of about 2 to about 10 μm, and a length before processing of about 2 to about 20 mm. Within the above ranges, the rigidity, processability, or the like of a thermoplastic resin composition may be improved.

In an embodiment, the glass fiber may be treated with a conventional surface treatment agent. As the surface treatment agent, a silane-based compound, a urethane-based compound, an epoxy-based compound, or the like may be used, but it is not limited thereto.

In an embodiment, the glass fiber may be comprised in an amount of about 15 to about 70 parts by weight, for example, about 20 to about 50 parts by weight, specifically about 25 to about 42 parts by weight, based on about 100 parts by weight of the polycarbonate resin. When the content of the glass fiber is less than about 15 parts by weight based on about 100 parts by weight of the polycarbonate resin, there is a concern that the impact resistance, rigidity, or the like of a thermoplastic resin composition (molded article) may be reduced, and the molded article may be twisted or bent, and when it exceeds about 70 parts by weight, there is a concern that the flowability (processability), appearance characteristics, or the like of a thermoplastic resin composition (molded product) may be reduced.

### (D) Epoxy-Modified Polystyrene

The epoxy-modified polystyrene according to one embodiment of the present invention may be applied together with a styrene-ethylene/butylene-styrene copolymer, DOPO, or the like to improve the impact resistance, flowability, appearance characteristics, or the like of a thermoplastic resin composition comprising a polycarbonate resin, a polyphenylene ether resin, and glass fiber and lower the dielectric constant, dielectric loss rate, or the like thereof.

In an embodiment, the epoxy-modified polystyrene may be obtained by polymerizing polystyrene with an epoxy compound comprising one or more of glycidyl (meth)acrylate, allyl glycidyl ether, and 2-methylallyl glycidyl ether.

In an embodiment, in the epoxy-modified polystyrene, the content of the epoxy compound may be of about 0.3% by weight to about 3% by weight, for example, about 1% by weight to about 2% by weight, based on 100% by weight of the total epoxy-modified polystyrene. Within the above range, the thermoplastic resin composition may have excellent flowability, appearance characteristics, impact resistance, or the like, and may have excellent compatibility among the components.

In an embodiment, the epoxy-modified polystyrene may comprise glycidyl (meth)acrylate-modified polystyrene.

In an embodiment, the epoxy-modified polystyrene may have a melt flow index (MI) of about 25 to about 45 g/10 min, for example, about 30 to about 40 g/10 min, as measured under conditions of 190° C. and 2.16 kgf according to ASTM D1238. Within the above range, the thermoplastic resin composition may have excellent appearance characteristics, impact resistance, or the like, and may have excellent compatibility among the components.

In an embodiment, the epoxy-modified polystyrene may be comprised in an amount of about 1 to about 10 parts by weight, for example, about 2 to about 5 parts by weight, based on about 100 parts by weight of the polycarbonate resin. When the content of the epoxy-modified polystyrene is less than about 1 part by weight based on about 100 parts by weight of the polycarbonate resin, there is a concern that the impact resistance, appearance characteristics, or the like of a thermoplastic resin composition (molded article) may be reduced, and when the content exceeds about 10 parts by weight, there is a concern that the appearance characteristics, thermal stability, or the like of a thermoplastic resin composition (molded article) may be reduced, and the dielectric loss rate may increase.

### (E) Styrene-Ethylene/Butylene-Styrene Copolymer

As the styrene-ethylene/butylene-styrene copolymer according to one embodiment of the present invention, a styrene-ethylene/butylene-styrene copolymer applied to a conventional thermoplastic resin composition may be used, as long as it may be applied together with epoxy-modified polystyrene, DOPO, or the like to improve the impact resistance, flowability, appearance characteristics, or the like of a thermoplastic resin composition comprising a polycarbonate resin, a polyphenylene ether resin, and glass fiber and lower the dielectric constant, dielectric loss rate, or the like thereof.

In an embodiment, the styrene-ethylene/butylene-styrene copolymer may have a melt flow index (MI) of about 10 to about 50 g/10 min, for example, about 12 to about 48 g/10 min, as measured under conditions of 200° C. and 5 kgf according to ASTM D1238. Within the above range, the thermoplastic resin composition may have excellent impact resistance, flowability, appearance characteristics, moldability, or the like.

In an embodiment, the styrene-ethylene/butylene-styrene copolymer may be comprised in an amount of about 1 to about 20 parts by weight, for example, about 5 to about 10 parts by weight, based on about 100 parts by weight of the polycarbonate resin. When the content of the styrene-ethylene/butylene-styrene copolymer is less than about 1 part by weight based on about 100 parts by weight of the polycarbonate resin, there is a concern that the impact resistance, appearance characteristics, or the like of a thermoplastic resin composition (molded article) may be reduced, when it exceeds about 20 parts by weight, there is a concern that the flowability (processability), appearance characteristics, or the like of a thermoplastic resin composition (molded article) may be reduced, and the dielectric loss rate may increase.

In an embodiment, the weight ratio (D:E) of the epoxy-modified polystyrene (D) and the styrene-ethylene/butylene-styrene copolymer (E) may be from about 1:0.5 to about 1:10, for example, about 1:1 to about 1:4. When the weight ratio (D:E) is less than about 1:0.5, there is a concern that the impact resistance, appearance characteristics, or the like of the thermoplastic resin composition (molded article) may be reduced, and when it exceeds about 1:10, there is a concern that the flowability, appearance characteristics, compatibility, or the like of the thermoplastic resin composition (molded article) may be reduced, and the dielectric loss rate may increase.

### (F) DOPO

As the DOPO (9,10-dihydro-9-oxa-10-phosphahenanthrene-10-oxide) according to one embodiment of the present invention, DOPO used in a conventional thermoplastic resin composition may be used, as long as it may be applied together with epoxy-modified polystyrene, a styrene-ethylene/butylene-styrene copolymer, or the like to improve the impact resistance, flowability, appearance characteristics, or the like of a thermoplastic resin composition comprising a polycarbonate resin, a polyphenylene ether resin, and glass fiber and lower the dielectric constant, dielectric loss rate, or the like thereof.

In an embodiment, the DOPO may be comprised in an amount of about 0.2 to about 4 parts by weight, for example, about 1 to about 2 parts by weight, based on about 100 parts by weight of the polycarbonate resin. When the content of DOPO is less than about 0.2 parts by weight based on about 100 parts by weight of the polycarbonate resin, there is a concern that the impact resistance, appearance characteristics, thermal stability, or the like of a thermoplastic resin composition (molded article) may be reduced, and when it exceeds about 4 parts by weight, there is a concern that the impact resistance, flowability, appearance characteristics, or the like of the thermoplastic resin composition (molded article) may be reduced, and the dielectric loss rate, or the like may increase.

In an embodiment, the weight ratio (D:F) of the epoxy-modified polystyrene (D) and the DOPO (F) may be from about 1:0.1 to about 1:0.8, for example, from about 1:0.2 to about 1:0.7, specifically, about 1:0.3 to about 1:0.5. Within the above range, the thermoplastic resin composition (molded article) may have better appearance characteristics, flowability (moldability), or the like.

The thermoplastic resin composition according to one embodiment of the present invention may further comprise additives comprised in a conventional thermoplastic resin composition. Examples of the additives may comprise, flame retardants, antioxidants, anti-dripping agents, lubricants, release agents, nucleating agents, antistatic agents, stabilizers, pigments, dyes, and mixtures thereof, but are not limited thereto. When the additive is used, the content thereof may be about 0.001 to about 40 parts by weight, for example, about 0.1 to about 10 parts by weight, based on about 100 parts by weight of the polycarbonate resin.

The thermoplastic resin composition according to one embodiment of the present invention may be in the form of a pellet produced by mixing the above components and melt-extruding the same using a conventional twin-screw extruder at about 200 to 280° C., for example, about 220 to 260° C.

In an embodiment, the thermoplastic resin composition may have a notched Izod impact strength of about 10 to about 20 kgf·cm/cm, for example, about 13 to about 17 kgf·cm/cm, as measured with of a ⅛″ thick specimen according to ASTM D256.

In an embodiment, the thermoplastic resin composition may have a melt flow index (MI) of about 5 to about 10 g/10 min, for example, about 7 to about 9 g/10 min, as measured under conditions of 300° C. and 1.2 kgf according to ASTM D1238.

In an embodiment, the thermoplastic resin composition may have a glossiness of about 50 to about 70 GU, for example, about 55 to about 65 GU, as measured at a reflection angle of 75° using a glossmeter.

In an embodiment, the thermoplastic resin composition may have a dielectric constant (Dk) of about 2.6 to about 2.8, for example, about 2.6 to about 2.7, as measured with a specimen having a size of 2.5 mm×50 mm×90 mm at 3.1 GHz using a split post dielectric resonator (SPDR) method (using DAK3.5-TL-P (20-MHz-20 GHz equipment and DAK1.2E-PL probe).

In an embodiment, the thermoplastic resin composition may have a dielectric loss rate (Df) of about 0.004 to about 0.006, for example, about 0.0045 to about 0.0055, as measured with a specimen having a size of 2.5 mm×50 mm×90 mm at 3.1 GHz using a split post dielectric resonator (SPDR) method (using DAK3.5-TL-P (20-MHz-20 GHz equipment and DAK1.2E-PL probe).

The molded article according to the present invention is formed from the thermoplastic resin composition. The thermoplastic resin composition may be manufactured in the form of a pellet, and the manufactured pellet may be manufactured into various molded articles (products) through various molding methods such as injection molding, extrusion molding, vacuum molding, and casting molding. These molding methods are well known to those skilled in the art. The molded article has excellent impact resistance, flowability, appearance characteristics, or the like and a low dielectric constant and dielectric loss rate, and thus is useful as a housing for electrical and electronic products and a housing for mobile devices such as smartphones.

### MODE FOR INVENTION

Next, the present invention will be described in more detail with reference to some examples. It should be understood that these examples are provided for illustration only and are not to be construed in any way as limiting the present invention.

### EXAMPLE

Details of components used in Examples and Comparative Examples are as follows.

### (A) Polycarbonate Resin

A bisphenol-A-based polycarbonate resin (manufacturer: Lotte Chemical, weight average molecular weight: approximately 22,000 g/mol) was used.

### (B) Polyphenylene Ether Resin

A poly(1,4-phenylene) ether resin (manufacturer: Bluestar New Chemical Material Co., Ltd., product name: LXR-050C) was used.

### (C) Glass Fiber

Circular cross-section glass fiber (manufacturer: Chongqing Polycomp International Corp., product name: ECS303W-3-E) was used.

### (D) Polystyrene

(D1) As epoxy-modified polystyrene, glycidyl methacrylate-modified polystyrene (PS-g-GMA, manufacturer: Fine-blend Polymer Co., Ltd., product name: SG-20) with about 2% by weight of a glycidyl methacrylate content was used.
(D2) Polystyrene (GPPS, manufacturer: Formosa Chemicals & Fibre Corp., product name: TAIRIREX GP-5000) was used.

### (E) Vinyl-Based Copolymer

(E1) A styrene-ethylene/butylene-styrene copolymer (manufacturer: Kraton Corp., product name: G1650) was used.
(E2) A styrene-isobutylene/butylene-styrene copolymer (manufacturer: Kaneka Corp., product name: 073T) was used.

### (F) DOPO

Dihydro-9-oxa-10-phosphapheneanthrene-10-oxide (DOPO) (manufacturer: Shouguang Weidong Chemical Co., Ltd., product name: DOPO) was used.

### Examples 1 to 11 and Comparative Examples 1 to 14

Each of the components above was added in the contents shown in Tables 1, 2, 3, and 4 below, and then extruded at about 260° C. to manufacture pellets. For extrusion, a twin-screw extruder with L/D=44 and a diameter of 45 mm was used, and the manufactured pellets were dried at approximately 80° C. for 4 hours or more and then subjected to injection molding in a 6 oz injection molding machine (molding temperature: approximately 280° C., mold temperature: approximately 70° C.) to manufacture specimens. The physical properties of the manufactured specimens were evaluated by the methods below, and the results are shown in Tables 1, 2, 3, and 4 below.

### Property Evaluation

(1) Impact resistance (units: kgf·cm/cm): According to ASTM D256, the notched Izod impact strength of a ⅛″ thick specimen was measured.
(2) Flowability (units: g/10 min): According to ASTM D1238, the melt flow index (MI) was measured under conditions of 300° C. and 1.2 kgf.
(3) Appearance characteristics (units: GU): The glossiness of an injection molded specimen with a size of 100 mm×100 mm×3.2 mm was measured at a reflection angle of 75° using a glossmeter (manufacturer: BYK Instruments, instrument name: micro-gloss).
(4) Dielectric constant: Using the split post dielectric resonator (SPDR) method (using DAK3.5-TL-P (200 MHz-20 GHz) equipment and DAK1.2E-PL probe), the dielectric constant (Dk) of a specimen with a size of 2.5 mm×50 mm×90 mm was measured at 3.1 GHz.
(5) Dielectric loss rate: Using the split post dielectric resonator (SPDR) method (using DAK3.5-TL-P (200 MHz-20 GHz) equipment and DAK1.2E-PL probe), the dielectric loss rate (Df) of a specimen with a size of 2.5 mm×50 mm×90 mm was measured at 3.1 GHz.

TABLE 1

| | Examples | | | | |
|---|---|---|---|---|---|
| | 1 | 2 | 3 | 4 | 5 |
| (A) (Parts by weight) | 100 | 100 | 100 | 100 | 100 |
| (B) (Parts by weight) | 30 | 45 | 78 | 45 | 45 |
| (C) (Parts by weight) | 36 | 36 | 36 | 25 | 42 |
| (D1) (Parts by weight) | 5 | 5 | 5 | 5 | 5 |
| (D2) (Parts by weight) | — | — | — | — | — |
| (E1) (Parts by weight) | 7 | 7 | 7 | 7 | 7 |
| (E2) (Parts by weight) | — | — | — | — | — |
| (F) (Parts by weight) | 1.5 | 1.5 | 1.5 | 1.5 | 1.5 |
| Notched Izod impact | 14 | 15 | 14 | 16 | 15 |
| strength | | | | | |
| Melt flow index | 7.5 | 8 | 8.2 | 7.8 | 7.4 |
| Glossiness | 65 | 65 | 63 | 64 | 65 |
| Dielectric constant | 2.65 | 2.64 | 2.64 | 2.65 | 2.68 |
| Dielectric loss rate | 0.0045 | 0.0046 | 0.0051 | 0.0048 | 0.0049 |

TABLE 2

| | Examples | | | | | |
|---|---|---|---|---|---|---|
| | 6 | 7 | 8 | 9 | 10 | 11 |
| (A) (Parts by weight) | 100 | 100 | 100 | 100 | 100 | 100 |
| (B) (Parts by weight) | 45 | 45 | 45 | 45 | 45 | 45 |
| (C) (Parts by weight) | 36 | 36 | 36 | 36 | 36 | 36 |
| (D1) (Parts by weight) | 2.1 | 4.8 | 5 | 5 | 5 | 5 |
| (D2) (Parts by weight) | — | — | — | — | — | — |
| (E1) (Parts by weight) | 7 | 7 | 5 | 10 | 7 | 7 |
| (E2) (Parts by weight) | — | — | — | — | — | — |
| (F) (Parts by weight) | 1.5 | 1.5 | 1.5 | 1.5 | 1 | 2 |
| Notched Izod impact | 15 | 14 | 16 | 14 | 15 | 16 |
| strength | | | | | | |
| Melt flow index | 8.0 | 8.1 | 7.5 | 7.8 | 8.1 | 7.9 |
| Glossiness | 64 | 64 | 63 | 65 | 64 | 65 |
| Dielectric constant | 2.60 | 2.61 | 2.61 | 2.63 | 2.64 | 2.62 |
| Dielectric loss rate | 0.0051 | 0.0045 | 0.0048 | 0.0047 | 0.0050 | 0.0049 |

TABLE 3

| | Comparative Examples | | | | | | |
|---|---|---|---|---|---|---|---|
| | 1 | 2 | 3 | 4 | 5 | 6 | 7 |
| (A) (Parts by weight) | 100 | 100 | 100 | 100 | 100 | 100 | 100 |
| (B) (Parts by weight) | 15 | 85 | 45 | 45 | 45 | 45 | 45 |
| (C) (Parts by weight) | 36 | 36 | 10 | 75 | 36 | 36 | 36 |
| (D1) (Parts by weight) | 5.5 | 5.5 | 5.5 | 5.5 | 0.5 | 15 | — |
| (D2) (Parts by weight) | — | — | — | — | — | — | 5.5 |
| (E1) (Parts by weight) | 7 | 7 | 7 | 7 | 7 | 7 | 7 |
| (E2) (Parts by weight) | — | — | — | — | — | — | — |
| (F) (Parts by weight) | 1.5 | 1.5 | 1.5 | 1.5 | 1.5 | 1.5 | 1.5 |
| Notched Izod impact | 14 | 7 | 8 | 18 | 7 | 14 | 7 |
| strength | | | | | | | |
| Melt flow index | 8 | 2 | 9 | 1.5 | 9 | 8 | 12 |
| Glossiness | 62 | 20 | 65 | 10 | 25 | 20 | 25 |
| Dielectric constant | 2.90 | 2.45 | 2.50 | 3.20 | 2.52 | 2.80 | 2.64 |
| Dielectric loss rate | 0.0075 | 0.0041 | 0.0040 | 0.0087 | 0.0049 | 0.0065 | 0.0052 |

TABLE 4

| | Comparative Examples | | | | | | |
|---|---|---|---|---|---|---|---|
| | 8 | 9 | 10 | 11 | 12 | 13 | 14 |
| (A) (Parts by weight) | 100 | 100 | 100 | 100 | 100 | 100 | 100 |
| (B) (Parts by weight) | 45 | 45 | 45 | 45 | 45 | 45 | 45 |
| (C) (Parts by weight) | 36 | 36 | 36 | 36 | 36 | 36 | 36 |
| (D1) (Parts by weight) | 5.5 | 5.5 | 5.5 | 5.5 | 5.5 | 10 | 1 |
| (D2) (Parts by weight) | — | — | — | — | — | — | — |
| (E1) (Parts by weight) | 0.5 | 25 | — | 7 | 7 | 4 | 11 |
| (E2) (Parts by weight) | — | — | 7 | — | | — | — |
| (F) (Parts by weight) | 1.5 | 1.5 | 1.5 | 0.1 | 6 | 1.5 | 1.5 |
| Notched Izod impact | 3 | 20 | 6 | 9 | 7 | 9 | 15 |
| strength | | | | | | | |
| Melt flow index | 10 | 3 | 9 | 8 | 25 | 7 | 3 |
| Glossiness | 60 | 30 | 25 | 21 | 18 | 36 | 24 |
| Dielectric constant | 2.46 | 2.75 | 2.75 | 2.50 | 2.80 | 2.75 | 2.80 |
| Dielectric loss rate | 0.0042 | 0.0061 | 0.0058 | 0.0048 | 0.0061 | 0.0058 | 0.0061 |

From the results above, it can be seen that the thermoplastic resin composition of the present invention has excellent impact resistance, flowability, appearance characteristics, or the like and a low dielectric constant and dielectric loss rate.

On the other hand, it can be seen that in the case of Comparative Example 1 in which a small amount of the polyphenylene ether resin was applied, the dielectric constant, dielectric loss rate, or the like were high; in the case of Comparative Example 2 in which an excessive amount of the polyphenylene ether resin was applied, impact resistance, flowability, appearance characteristics, or the like were reduced; in the case of Comparative Example 3 in which a small amount of glass fiber was applied, impact resistance, or the like were reduced; and in the case of Comparative Example 4 in which an excessive amount of glass fiber was applied, flowability, appearance characteristics, or the like were reduced, and the dielectric constant, dielectric loss rate, or the like were high. It can be seen that in the case of Comparative Example 5 in which a small amount of the epoxy-modified polystyrene was applied, impact resistance, appearance characteristics, or the like, were reduced; in the case of Comparative Example 6 in which an excessive amount of the epoxy-modified polystyrene was applied, the appearance characteristics, or the like were reduced, and the dielectric loss rate, or the like were high; and in the case of Comparative Example 7 in which polystyrene (D2) was used instead of the epoxy-modified polystyrene of the present invention, impact resistance, appearance characteristics, or the like were reduced. It can be seen that in the case of Comparative Example 8 in which a small amount of the styrene-ethylene/butylene-styrene copolymer was applied, impact resistance, or the like were reduced; in the case of Comparative Example 9 in which an excessive amount of the styrene-ethylene/butylene-styrene copolymer was applied, flowability, appearance characteristics, or the like were reduced, and the dielectric loss rate was high; and in the case of Comparative Example 10 in which styrene-isobutylene/butylene-styrene copolymer (E2) was applied instead of the styrene-ethylene/butylene-styrene copolymer of the present invention, impact resistance, appearance characteristics, or the like were reduced. It can be seen that in the case of Comparative Example 11 in which a small amount of DOPO was applied, impact resistance, appearance characteristics, or the like were reduced; and in the case of Comparative Example 12 in which an excessive amount of DOPO was applied, impact resistance, flowability, appearance characteristics, or the like were reduced, and the dielectric loss rate, or the like were high.

In addition, it can be seen that even when the content of the epoxy-modified polystyrene and the styrene-ethylene/butylene-styrene copolymer was comprised in the scope of the present invention, when the weight ratio (D:E) of the epoxy-modified polystyrene and the styrene-ethylene/butylene-styrene copolymer was less than 1:0.5 (1:0.4) (Comparative Example 13), impact resistance, appearance characteristics, or the like were reduced; and when it exceeded 1:10 (1:11) (Comparative Example 14), flowability, appearance characteristics, or the like were reduced, and the dielectric loss rate, or the like were high.

Although some embodiments have been described herein, it will be understood by those skilled in the art that various modifications, changes, and alterations can be made without departing from the spirit and scope of the invention. Therefore, it should be understood that these embodiments are provided for illustration only and are not to be construed in any way as limiting the present invention. The scope of the present invention should be defined by the appended claims rather than by the foregoing description, and the claims and equivalents thereto are intended to cover such modifications and the like as would fall within the scope of the present invention.

1. A thermoplastic resin composition comprising:
about 100 parts by weight of a polycarbonate resin;
about 20 to about 80 parts by weight of a polyphenylene ether resin;
about 15 to about 70 parts by weight of glass fiber;
about 1 to about 10 parts by weight of an epoxy-modified polystyrene;
about 1 to about 20 parts by weight of a styrene-ethylene/butylene-styrene copolymer; and
about 0.2 to about 4 parts by weight of dihydro-9-oxa-10-phosphaphenanthrene-10-oxide (DOPO),
wherein a weight ratio of the epoxy-modified polystyrene and the styrene-ethylene/butylene-styrene copolymer is about 1:0.5 to about 1:10.

2. The thermoplastic resin composition of claim 1, wherein the polyphenylene ether resin comprises a repeating unit represented by Chemical Formula 1 below: 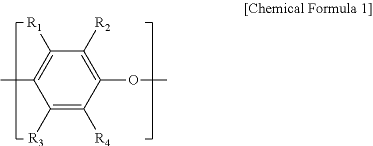
wherein in Chemical Formula 1 above, R₁, R₂, R₃, and R₄ are each independently a hydrogen atom, a halogen atom, a C1 to C6 alkyl group or a C6 to C12 aryl group.

3. The thermoplastic resin composition of claim 1, wherein the epoxy-modified polystyrene is obtained by polymerizing polystyrene with an epoxy compound comprising one or more of glycidyl (meth)acrylate, allyl glycidyl ether, and 2-methylallyl glycidyl ether.

4. The thermoplastic resin composition of claim 3, wherein the content of the epoxy compound in the epoxy-modified polystyrene is about 0.5% by weight to about 3% by weight.

5. The thermoplastic resin composition of claim 1, wherein the epoxy-modified polystyrene comprises glycidyl (meth)acrylate-modified polystyrene.

6. The thermoplastic resin composition of claim 1, wherein the styrene-ethylene/butylene-styrene copolymer has a melt flow index (MI) of about 10 to about 50 g/10 min, as measured under conditions of 200° C. and 5 kgf according to ASTM D1238.

7. The thermoplastic resin composition of claim 1, wherein a weight ratio of the epoxy-modified polystyrene and the DOPO is about 1:0.1 to about 1:0.8.

8. The thermoplastic resin composition of claim 1, wherein the thermoplastic resin composition has a notched Izod impact strength of about 10 to about 20 kgf·cm/cm, as measured with a ⅛″ thick specimen according to ASTM D256.

9. The thermoplastic resin composition of claim 1, wherein the thermoplastic resin composition has a melt flow index (MI) of about 5 to about 10 g/10 min, as measured under conditions of 300° C. and 1.2 kgf according to ASTM D1238.

10. The thermoplastic resin composition of claim 1, wherein the thermoplastic resin composition has a glossiness of about 50 to about 70 GU, as measured at a reflection angle of 75° using a glossmeter.

11. The thermoplastic resin composition of claim 1, wherein the thermoplastic resin composition has a dielectric constant (Dk) of about 2.6 to about 2.8, as measured with a specimen having a size of 2.5 mm×50 mm×90 mm at 3.1 GHz using a split post dielectric resonator (SPDR) method.

12. The thermoplastic resin composition of claim 1, wherein the thermoplastic resin composition has a dielectric loss rate (Df) of about 0.004 to about 0.006, as measured with a specimen having a size of 2.5 mm×50 mm×90 mm at 3.1 GHz using a split post dielectric resonator (SPDR) method.

13. A molded article formed from the thermoplastic resin composition of claim 1.
